(19) United States
(12) Patent Application Publication
(10) Pub. No.: US 2024/0011792 A1
(43) Pub. Date: Jan. 11, 2024

(54) METHOD AND APPARATUS FOR UPDATING CONFIDENCE OF HIGH-PRECISION MAP

(71) Applicant: Beijing Co Wheels Technology Co., Ltd, Beijing (CN)

(72) Inventor: Wei WU, Beijing (CN)

(21) Appl. No.: 18/246,003

(22) PCT Filed: Oct. 13, 2021
(86) PCT No.: PCT/CN2021/123654

§ 371 Date: Mar. 20, 2023

(30) Foreign Application Priority Data
Dec. 1, 2020 (CN) 202011387388.7

(51) Int. Cl. G01C 21/00; B60W 60/00

(52) U.S. Cl. CPC G01C 21/3841; G01C 21/3815; G01C 21/3896; B60W 60/001; B60W 2556/20; B60W 2556/40; B60W 2556/50

(57) ABSTRACT

A method for updating a confidence of a high-precision map includes: acquiring confidence updating data packets corresponding to target vehicles, wherein the confidence updating data packets include target road element images corresponding to each of the target road elements, shooting position information corresponding to each target road element image and a camera calibration file, or include pieces of first comparison result information corresponding to each of the target road elements; updating an original confidence value corresponding to the target road section in the high-precision map according to the target road element images corresponding to each of the target vehicles, the shooting position information corresponding to each of the target road element images and the camera calibration file; or updating the original confidence value corresponding to the target road section in the high-precision map according to the pieces of first comparison result information corresponding to each of the target vehicles.

### CROSS-REFERENCE TO RELATED APPLICATION

This application is based upon and claims priority to Chinese Patent Application No. 202011387388.7, filed Dec. 1, 2020, the entire contents of which are incorporated herein by reference.

### FIELD

The present disclosure relates to the technical field of high-precision maps, and more particularly to a method and apparatus for updating a confidence of a high-precision map.

### BACKGROUND

With the continuous development of science and technology, automatic driving technology has also developed rapidly. Among others, a high-precision map is the basis for realizing automatic driving, which includes a large amount of road elements such as road identifications, lane lines, traffic lights and traffic signs. Due to road construction and other reasons, the positions or attributes of the road elements like the road identifications, the lane lines, the traffic lights and traffic signs in some road sections will be changed, which will reduce the confidence values of these road sections in the high-precision map, while an automatic driving vehicle is based on confidence values of various road sections to select an automatic driving mode. Therefore, in order to ensure the driving safety of automatic driving vehicles, the confidence values of the respective road sections in the high-precision map needs to be updated in time.

At present, the confidence values of the respective road sections in the high-precision map are updated using a centralized drawing method, that is, a high-precision map manufacturer collects position information and attribute information corresponding to each road element in the target road section through self-modified data acquiring vehicles, and then updates the confidence value corresponding to the target road section in the high-precision map according to the position information and the attribute information corresponding to each road element collected by the data acquiring vehicles. However, due to the high cost for modifying the data acquiring vehicles, the cost for updating the confidence values corresponding to the respective road sections in the high-precision map is also high.

### SUMMARY

Embodiments of the present disclosure provide a method and apparatus for updating a confidence of a high-precision map, whose main objective is to reduce the cost for updating the confidence value of the high-precision map, on the basis of ensuring that confidence values corresponding to respective road sections in the high-precision map are updated in time.

In order to solve the above technical problems, embodiments of the present disclosure provide the following technical solutions.

In a first aspect, the present disclosure provides a method for updating a confidence of a high-precision map, which includes:
acquiring confidence updating data packets corresponding to target vehicles, wherein the confidence updating data packets corresponding to target vehicles are confidence updating data packets uploaded to a cloud server when each of target vehicles passes through a target road section within a target time period, the target road section includes a plurality of target road elements, the confidence updating data packets include target road element images corresponding to each of the target road elements, shooting position information corresponding to each of the target road element images and a camera calibration file, or the confidence updating data packets include pieces of first comparison result information corresponding to each of the target road elements;
updating an original confidence value corresponding to the target road section in the high-precision map according to the target road element images corresponding to each of the target vehicles, the shooting position information corresponding to each of the target road element images and the camera calibration file; or
updating the original confidence value corresponding to the target road section in the high-precision map according to the pieces of first comparison result information corresponding to each of the target vehicles.

Optionally, the updating the original confidence value corresponding to the target road section in the high-precision map according to the target road element images corresponding to each of the target vehicles, the shooting position information corresponding to each of the target road element images and the camera calibration file includes:
determining collection element position information and a collection element attribute corresponding to each of the target road elements acquired by each of the target vehicles according to the target road element images corresponding to each of the target vehicles, the shooting position information corresponding to each of the target road element images and the camera calibration file, wherein the collection element position information corresponding to each of the target road elements is position information of the target road element relative to the high-precision map; and
updating the original confidence value corresponding to the target road section in the high-precision map according to the collection element position information and the collection element attribute corresponding to each of the target road elements acquired by each of the target vehicles.

Optionally, the determining the collection element position information and the collection element attribute corresponding to each of the target road elements acquired by each of the target vehicles according to the target road element images corresponding to each of the target vehicles, the shooting position information corresponding to each of the target road element images and the camera calibration file includes:
determining a first position and the collection element attribute corresponding to each of the target road elements acquired by the target vehicle according to a preset perceptual recognition algorithm and the target road element images corresponding to the target vehicle, wherein the first position corresponding to the target road element is a position of the target road element in the respective target road element image;
determining a second position corresponding to each of the target road elements acquired by the target vehicle according to the first position corresponding to each of the target road elements acquired by the target vehicle and the camera calibration file corresponding to the target vehicle, wherein the second position corresponding to the target road element is a position of the target road element relative to the target vehicle; and
determining the collection element position information corresponding to each of the target road elements acquired by each of the target vehicles according to the second position corresponding to each of the target road elements acquired by the target vehicle and the shooting position information corresponding to each of the target road element images.

Optionally, the updating the original confidence value corresponding to the target road section in the high-precision map according to the collection element position information and the collection element attribute corresponding to each of the target road elements acquired by each of the target vehicles includes:
acquiring original element position information, an original element attribute and an original confidence value corresponding to each of the target road elements from the high-precision map;
comparing the collection element position information and the collection element attribute corresponding to each of the target road elements acquired by each of the target vehicles with the original element position information and the original element attribute corresponding to each of the target road elements, respectively, to obtain pieces of second comparison result information corresponding to each of the target road elements;
subtracting a first preset confidence threshold corresponding to a target road element from the original confidence value corresponding to the target road element to obtain an updated confidence value corresponding to the target road element, when a proportion of the number of pieces of error comparison result information in the pieces of second comparison result information corresponding to the target road element to the number of the pieces of second comparison result information is greater than a preset proportion threshold;
determining a first updated confidence value corresponding to the target road section according to the updated confidence value corresponding to each of the target road elements; and
updating the original confidence value corresponding to the target road section in the high-precision map using the first updated confidence value corresponding to the target road section.

Optionally, the updating the original confidence value corresponding to the target road section in the high-precision map according to the collection element position information and the collection element attribute corresponding to each of the target road elements acquired by each of the target vehicles includes:
acquiring original element position information, an original element attribute and an original confidence value corresponding to each of the target road elements from the high-precision map;
comparing the collection element position information and the collection element attribute corresponding to each of the target road elements acquired by each of the target vehicles with the original element position information and the original element attribute corresponding to each of the target road elements, respectively, to obtain pieces of second comparison result information corresponding to each of the target road elements;
determining the number of pieces of error comparison result information corresponding to the target road element according to the pieces of second comparison result information corresponding to the target road element;
obtaining an updated confidence value corresponding to the target road element by subtracting a product of a second preset confidence threshold and the number of the pieces of error comparison result information corresponding to the target road element from the original confidence value corresponding to the target road element;
determining a first updated confidence value corresponding to the target road section according to the updated confidence value corresponding to each of the target road elements; and
updating the original confidence value corresponding to the target road section in the high-precision map using the first updated confidence value corresponding to the target road section.

Optionally, the updating the original confidence value corresponding to the target road section in the high-precision map according to the pieces of first comparison result information corresponding to each of the target vehicles includes:
subtracting a first preset confidence threshold corresponding to the target road element from an original confidence value corresponding to the target road element to obtain an updated confidence value corresponding to the target road element, when a proportion of the number of pieces of error comparison result information in the pieces of first comparison result information corresponding to the target road element to the number of the pieces of first comparison result information is greater than a preset proportion threshold;
determining a first updated confidence value corresponding to the target road section according to the updated confidence value corresponding to each of the target road elements; and
updating the original confidence value corresponding to the target road section in the high-precision map using the first updated confidence value corresponding to the target road section.

Optionally, the updating the original confidence value corresponding to the target road section in the high-precision map according to the pieces of first comparison result information corresponding to each of the target vehicles includes:
determining the number of pieces of error comparison result information corresponding to the target road element according to the pieces of first comparison result information corresponding to the target road element;
obtaining an updated confidence value corresponding to the target road element by subtracting a product of a second preset confidence threshold and the number of pieces of error comparison result information corresponding to the target road element from an original confidence value corresponding to the target road element;
determining a first updated confidence value corresponding to the target road section according to the updated confidence value corresponding to each of the target road elements; and
updating the original confidence value corresponding to the target road section in the high-precision map using the first updated confidence value corresponding to the target road section.

Optionally, after updating the original confidence value corresponding to the target road section in the high-precision map according to the target road element images corresponding to each of the target vehicles, the shooting position information corresponding to each of the target road element images and the camera calibration file; or updating the original confidence value corresponding to the target road section in the high-precision map according to the pieces of first comparison result information corresponding to each of the target vehicles, the method further includes: transmitting the first updated confidence value corresponding to the target road section to the target vehicles or other vehicles to enable the target vehicles or the other vehicles to select an automatic driving mode according to the first updated confidence value corresponding to the target road section in passing through the target road section.

Optionally, the method further includes:
subtracting a third preset confidence threshold from the original confidence value corresponding to the target road section to obtain a second updated confidence value corresponding to the target road element, in response to receiving no confidence updating data packet corresponding to the target road section within a preset time period; and
updating the original confidence value corresponding to the target road section in the high-precision map using the second updated confidence value corresponding to the target road section.

In a second aspect, embodiments of the present disclosure provide an apparatus for updating a confidence of a high-precision map. The apparatus includes:
an acquiring unit, configured to acquire confidence updating data packets corresponding to target vehicles, wherein the confidence updating data packets corresponding to target vehicles are confidence updating data packets uploaded to a cloud server when each of target vehicles passes through a target road section within a target time period, the target road section includes a plurality of target road elements, the confidence updating data packets include target road element images corresponding to each of the target road elements, shooting position information corresponding to each of the target road element images and a camera calibration file, or the confidence updating data packets include pieces of first comparison result information corresponding to each of the target road elements;
a first updating unit, configured to update an original confidence value corresponding to the target road section in the high-precision map according to the target road element images corresponding to each of the target vehicles, the shooting position information corresponding to each of the target road element images and the camera calibration file, when the confidence updating data packet corresponding to the target vehicle includes the target road element image corresponding to each of the target road elements, the shooting position information corresponding to each of the target road element images and the camera calibration file; or
a second updating unit, configured to update the original confidence value corresponding to the target road section in the high-precision map according to the pieces of first comparison result information corresponding to each of the target vehicles, when the confidence updating data packet corresponding to the target vehicle includes the pieces of first comparison result information corresponding to each of the target road elements.

Optionally, the first updating unit includes:
a first determining module, configured to determine collection element position information and a collection element attribute corresponding to each of the target road elements acquired by each of the target vehicles according to the target road element images corresponding to each of the target vehicles, the shooting position information corresponding to each of the target road element images and the camera calibration file, wherein the collection element position information corresponding to the target road element is position information of the target road element relative to the high-precision map; and
a first updating module, configured to update the original confidence value corresponding to the target road section in the high-precision map according to the collection element position information and the collection element attribute corresponding to each of the target road elements acquired by each of the target vehicles.

Optionally, the first determining module includes:
a first determining sub-module, configured to determine a first position and the collection element attribute corresponding to each of the target road elements acquired by the target vehicle according to a preset perceptual recognition algorithm and the target road element images corresponding to the target vehicle, wherein the first position corresponding to the target road element is a position of the target road element in the respective target road element image;
a second determining sub-module, configured to determine a second position corresponding to each of the target road elements acquired by the target vehicle according to the first position corresponding to each of the target road elements acquired by the target vehicle and the camera calibration file corresponding to the target vehicle, wherein the second position corresponding to the target road element is a position of the target road element relative to the target vehicle; and
a third determining sub-module, configured to determine the collection element position information corresponding to each of the target road elements acquired by the target vehicle according to the second position corresponding to each of the target road elements acquired by the target vehicle and the shooting position information corresponding to each of the target road element images.

Optionally, the first updating module includes:
a first acquiring sub-module, configured to acquire original element position information, an original element attribute and an original confidence value corresponding to each of the target road elements from the high-precision map;
a first comparing sub-module, configured to compare the collection element position information and the collection element attribute corresponding to each of the target road elements acquired by each of the target vehicles with the original element position information and the original element attribute corresponding to each of the target road elements, respectively, to obtain pieces of second comparison result information corresponding to each of the target road elements;
a first computing sub-module, configured to subtract a first preset confidence threshold corresponding to a target road element from the original confidence value corresponding to the target road element to obtain an updated confidence value corresponding to the target road element, when a proportion of the number of pieces of error comparison result information in the pieces of second comparison result information corresponding to the target road element to the number of the pieces of second comparison result information is greater than a preset proportion threshold;
a fourth determining sub-module, configured to determine a first updated confidence value corresponding to the target road section according to the updated confidence value corresponding to each of the target road elements; and
a first updating sub-module, configured to update the original confidence value corresponding to the target road section in the high-precision map using the first updated confidence value corresponding to the target road section.

Optionally, the first updating module further includes:
a second acquiring sub-module, configured to acquire original element position information, an original element attribute and an original confidence value corresponding to each of the target road elements from the high-precision map;
a second comparing sub-module, configured to compare the collection element position information and the collection element attribute corresponding to each of the target road elements acquired by each of the target vehicles with the original element position information and the original element attribute corresponding to each of the target road elements, respectively, to obtain pieces of second comparison result information corresponding to each of the target road elements;
a fifth determining sub-module, configured to determine the number of pieces of error comparison result information corresponding to the target road element according to the pieces of second comparison result information corresponding to the target road element;
a second computing sub-module, configured to obtain an updated confidence value corresponding to the target road element by subtracting a product of a second preset confidence threshold and the number of the pieces of error comparison result information corresponding to the target road element from the original confidence value corresponding to the target road element;
a sixth determining sub-module, configured to determine a first updated confidence value corresponding to the target road section according to the updated confidence value corresponding to each of the target road elements; and
a second updating sub-module, configured to update the original confidence value corresponding to the target road section in the high-precision map using the first updated confidence value corresponding to the target road section.

Optionally, the second updating unit includes:
a first computing module, configured to subtract a first preset confidence threshold corresponding to the target road element from an original confidence value corresponding to the target road element to obtain an updated confidence value corresponding to the target road element, when a proportion of the number of pieces of error comparison result information in the pieces of first comparison result information corresponding to the target road element to the number of the pieces of first comparison result information is greater than a preset proportion threshold;
a second determining module, configured to determine a first updated confidence value corresponding to the target road section according to the updated confidence value corresponding to each of the target road elements; and
a second updating module, configured to update the original confidence value corresponding to the target road section in the high-precision map using the first updated confidence value corresponding to the target road section.

Optionally, the second updating unit further includes:
a third determining module, configured to determine the number of pieces of error comparison result information corresponding to the target road element according to the pieces of first comparison result information corresponding to the target road element; and
a second computing module, configured to obtain an updated confidence value corresponding to the target road element by subtracting a product of a second preset confidence threshold and the number of pieces of error comparison result information corresponding to the target road element from an original confidence value corresponding to the target road element;
a fourth determining module, configured to determine a first updated confidence value corresponding to the target road section according to the updated confidence value corresponding to each of the target road elements; and
a third updating module, configured to update the original confidence value corresponding to the target road section in the high-precision map using the first updated confidence value corresponding to the target road section.

Optionally, the apparatus includes: a transmitting unit, configured to transmit the first updated confidence value corresponding to the target road section to the target vehicles or other vehicles to enable the target vehicles or the other vehicles to select an automatic driving mode according to the first updated confidence value corresponding to the target road section in passing through the target road section, after the first updating unit updates the original confidence value corresponding to the target road section in the high-precision map according to the target road element images corresponding to each of the target vehicles, the shooting position information corresponding to each of the target road element images and the camera calibration file, or after the second updating unit updates the original confidence value corresponding to the target road section in the high-precision map according to the pieces of first comparison result information corresponding to each of the target vehicles.

Optionally, the apparatus further includes:
a computing unit, configured to subtract a third preset confidence threshold from the original confidence value corresponding to the target road section to obtain a second updated confidence value corresponding to the target road section, in response to receiving no confidence updating data packet corresponding to the target road section within a preset time period; and
a third updating unit, configured to update the original confidence value corresponding to the target road section in the high-precision map using the second updated confidence value corresponding to the target road section.

In a third aspect, embodiments of the present disclosure provide a storage medium having stored therein instructions that, when executed, control a device in which the storage medium is disposed to execute the method for updating a confidence of a high-precision map as described in the first aspect.

In a fourth aspect, embodiments of the present disclosure provide an apparatus for updating a confidence of a high-precision map, including: a storage medium; and one or more processors, coupled to the storage medium. The one or more processors are configured to execute program instructions stored in the storage medium, and the program instructions, when executed, cause the method for updating a confidence of a high-precision map as described in the first aspect to be performed.

Through the above technical solutions, the technical solutions provided in embodiments of the present disclosure have at least the following advantages:

Embodiments of the present disclosure provide a method and apparatus for updating the confidence of a high-precision map. In contrast to updating the confidence values corresponding to respective road sections in a high-precision map by a centralized drawing method in the related art, embodiments of the present disclosure are able to acquire, at the cloud server, the confidence updating data packets (including the target road element image corresponding to each target road element in the target road section, the shooting position information corresponding to each target road element image and the camera calibration file corresponding to the respective target vehicle, or including pieces of first comparison result information corresponding to each target road element) acquired by target vehicles when each of target vehicles passes through the target road section within the target time period, and update, by the cloud server, the original confidence value corresponding to the target road section in the high-precision map according to the target road element images corresponding to each target vehicle, the shooting position information corresponding to each target road element image and the camera calibration file, or update, by the cloud server, the original confidence value corresponding to the target road section in the high-precision map according to the pieces of first comparison result information corresponding to each target vehicle. Since each target vehicle is an ordinary vehicle equipped with a preset camera and a GPS sensor, and the target vehicle, after acquiring the confidence updating data packet, will upload the confidence updating data packet to the cloud server, the cloud server can ensure that the confidence values corresponding to respective road sections in the high-precision map are updated in time, and at the same time, the cost for updating the confidence value of the high-precision map is reduced.

The above descriptions are only summary of the technical solutions of the present disclosure. For better understanding of the technical means of the present disclosure to make it implementable in accordance with the contents of the specification, and for making the above and other objectives, characteristics and advantages of the present disclosure more clearly and easy to understand, specific embodiments of the present disclosure are provided below.

### BRIEF DESCRIPTION OF THE DRAWINGS

Above and other objectives, characteristics and advantages of embodiments of the present disclosure will become easy to understand from the following descriptions with reference to the drawings. In the drawings, several embodiments of the present disclosure are provided for illustrating the present disclosure, which shall not be construed to limit the present disclosure. The same or similar parts are denoted by same or similar reference numerals.

FIG. 1 is a flowchart for illustrating a method for updating a confidence of a high-precision map according to an embodiment of the present disclosure;

FIG. 2 is a flowchart for illustrating a method for updating a confidence of a high-precision map according to another embodiment of the present disclosure;

FIG. 3 is a block diagram for illustrating an apparatus for updating a confidence of a high-precision map according to an embodiment of the present disclosure; and

FIG. 4 is a block diagram for illustrating an apparatus for updating a confidence of a high-precision map according to another embodiment of the present disclosure.

### DETAILED DESCRIPTION

Embodiments of the present disclosure will be described in more detail below with reference to the accompanying drawings. Although several embodiments of the present disclosure are provided in the accompanying drawings, it should be understood that the present disclosure can be implemented in various forms and shall not be limited by embodiments described herein. On the contrary, these embodiments are provided to enable those skilled in the art to better understand the present disclosure and its scope.

It should be noted that, unless specified otherwise, the technical terms or scientific terms used in present disclosure shall have the general meaning understood by those skilled in the art to which the present disclosure belongs.

Embodiments of the present disclosure provide a method for updating a confidence of a high-precision map. As shown in FIG. 1, the method includes the following steps.

At step 101, confidence updating data packets corresponding to a plurality of target vehicles are acquired.

The target vehicle is a vehicle passing through a target road section within a target time period. Specifically, the target vehicle is an ordinary vehicle equipped with a preset camera and a GPS sensor. The target road section includes a plurality of target road elements, which include, but are not limited to, target road identifications, target lane lines, target traffic lights, target traffic signs and the like in target road section. The confidence updating data packets corresponding to target vehicles are confidence updating data packets uploaded to a cloud server when each of the target vehicles passes through the target road section within the target time period. The confidence updating data packets include target road element images corresponding to each of the target road elements, shooting position information corresponding to each of the target road element images and a camera calibration file corresponding to the respective target vehicle, or the confidence updating data packets include pieces of first comparison result information corresponding to each of the target road elements. The first comparison result information corresponding to each target road element and included in the confidence updating data packet is determined by the target vehicle according to the target road element image corresponding to the target road element acquired by the target vehicle, the shooting position information corresponding to the target road element image, the camera calibration file corresponding to the target vehicle itself, and original element position information and an original element attribute corresponding to the target road element recorded in the high-precision map.

In embodiments of the present disclosure, the executive body of each step is the cloud server. For any target vehicle, when it passes through the target road section within the target time period, the target road element image corresponding to each target road element in the target road section is shot by the preset camera of the target vehicle, and position information of the target vehicle in the high-precision map is recorded by the GPS sensor when each target road element image is shot, so as to acquire the shooting position information corresponding to each target road element image. The target vehicle may upload the confidence updating data packet which includes the target road element image corresponding to each target road element, the shooting position information corresponding to each target road element image and the camera calibration file corresponding to the target vehicle itself to the cloud server. Alternatively, the target vehicle may determine the first comparison result information corresponding to each target road element according to the target road element image corresponding to each target road element acquired by the target vehicle itself, the shooting position information corresponding to each target road element image, the camera calibration file corresponding to the target vehicle itself, and the original element position information and the original element attribute corresponding to each target road element recorded in the high-precision map, and upload the confidence updating data packet which includes the first comparison result information corresponding to each target road element to the cloud server. In this way, when a preset updating time is reached, the cloud server is able to acquire the confidence updating data packets acquired by target vehicles when each of the target vehicles passes through the target road section within the target time period. The preset updating time may be, but not limited to, 00:00:00 or 12:00:00 every day, and the target time period may be, but not limited to, 24 hours, 48 hours, 36 hours and the like before the preset updating time.

At step 102a, an original confidence value corresponding to the target road section is updated in the high-precision map according to the target road element images corresponding to each target vehicle, the shooting position information corresponding to each target road element image and the camera calibration file.

In embodiments of the present disclosure, when the confidence updating data packet uploaded by each target vehicle specifically includes the target road element image corresponding to each target road element, the shooting position information corresponding to each target road element image and the camera calibration file corresponding to the target vehicle, the cloud server may update the original confidence value corresponding to the target road section in the high-precision map according to the target road element images corresponding to each target vehicle, the shooting position information corresponding to each target road element image and the camera calibration file. Specifically, the cloud server may determine an updated confidence value corresponding to each target road element according to the target road element images corresponding to each target vehicle, the shooting position information corresponding to each target road element image and the camera calibration file, determine an updated confidence value corresponding to the target road section according to the updated confidence value corresponding to each target road element, and update the original confidence value corresponding to the target road section in the high-precision map using the updated confidence value corresponding to the target road section.

In embodiments of the present disclosure, in parallel to the step 102a, a step 102b may be performed, in which the original confidence value corresponding to the target road section is updated in the high-precision map according to the pieces of first comparison result information corresponding to each target vehicle.

In embodiments of the present disclosure, when the confidence updating data packet uploaded by each target vehicle specifically includes the first comparison result information corresponding to each target road element, the cloud server may update the original confidence value corresponding to the target road section in the high-precision map according to the pieces of first comparison result information corresponding to each target vehicle. Specifically, the cloud server may determine an updated confidence value corresponding to each target road element according to the pieces of first comparison result information corresponding to each target vehicle, determine an updated confidence value corresponding to the target road section according to the updated confidence value corresponding to each target road element, and update the original confidence value corresponding to the target road section in the high-precision map using the updated confidence value corresponding to the target road section.

Embodiments of the present disclosure provide a method for updating the confidence of a high-precision map. In contrast to updating the confidence values corresponding to respective road sections in a high-precision map by a centralized drawing method in the related art, embodiments of the present disclosure are able to acquire, at the cloud server, the confidence updating data packets (including the target road element image corresponding to each target road element in the target road section, the shooting position information corresponding to each target road element image and the camera calibration file corresponding to the respective target vehicle, or including pieces of first comparison result information corresponding to each target road element) acquired by target vehicles when each of the target vehicles passes through the target road section within the target time period, and update, by the cloud server, the original confidence value corresponding to the target road section in the high-precision map according to the target road element images corresponding to each target vehicle, the shooting position information corresponding to each target road element image and the camera calibration file, or update, by the cloud server, the original confidence value corresponding to the target road section in the high-precision map according to the pieces of first comparison result information corresponding to each target vehicle. Since each target vehicle is an ordinary vehicle equipped with a preset camera and a GPS sensor, and the target vehicle, after acquiring the confidence updating data packet, will upload the confidence updating data packet to the cloud server, the cloud server can ensure that the confidence values corresponding to respective road sections in the high-precision map are updated in time, and at the same time, the cost for updating the confidence value of the high-precision map is reduced.

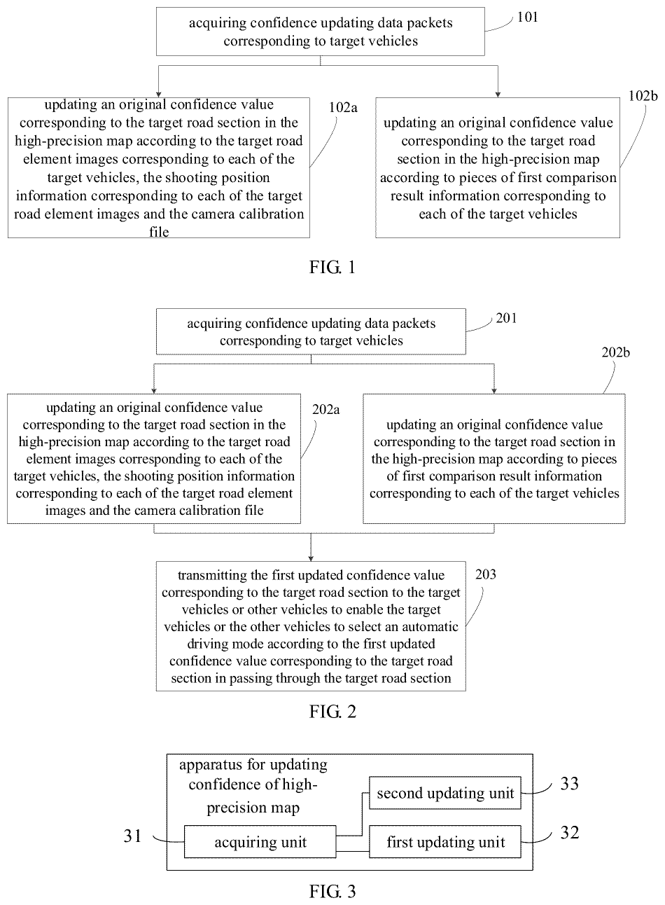

In the following, for illustrating the present disclosure in more detail, embodiments of the present disclosure provide another method for updating a confidence of a high-precision map. As shown in FIG. 2, the method includes the following steps.

At step 201, confidence updating data packets corresponding to target vehicles are required.

Regarding the step 201 of acquiring the confidence updating data packets corresponding to target vehicles, reference can be made to the relevant parts described above with respect to FIG. 1, which will not be elaborated herein.

At step 202a, an original confidence value corresponding to the target road section is updated in the high-precision map according to the target road element images corresponding to each target vehicle, the shooting position information corresponding to each target road element image and the camera calibration file.

In embodiments of the present disclosure, when the confidence updating data packet uploaded by each target vehicle specifically includes the target road element image corresponding to each target road element, the shooting position information corresponding to each target road element image and the camera calibration file corresponding to the target vehicle, the cloud server may update the original confidence value corresponding to the target road section in the high-precision map according to the target road element images corresponding to each target vehicle, the shooting position information corresponding to each target road element image and the camera calibration file. In the following, detailed description will be made on how the cloud server updates the original confidence value corresponding to the target road section in the high-precision map according to the target road element images corresponding to each target vehicle, the shooting position information corresponding to each target road element image and the camera calibration file.

(1) Collection element position information and a collection element attribute corresponding to each target road element acquired by each target vehicle are determined according to the target road element images corresponding to each target vehicle, the shooting position information corresponding to each target road element image and the camera calibration file.

The collection element position information corresponding to the target road element is position information of the target road element relative to the high-precision map.

Specifically, in this step, for any target vehicle, the cloud server may determine collection element position information and the collection element attribute corresponding to each target road element acquired by the target vehicle according to the target road element images corresponding to the target vehicle, the shooting position information corresponding to each target road element image and the camera calibration file through the following manner. Firstly, a first position and the collection element attribute corresponding to each target road element acquired by the target vehicle are determined according to a preset perceptual recognition algorithm and the target road element images corresponding to the target vehicle. The first position corresponding to a target road element is a position of the target road element in a respective target road element image. The preset perceptual recognition algorithm may be any existing deep learning recognition algorithm, which is not specified in embodiments of the present disclosure. Secondly, a second position corresponding to each target road element acquired by the target vehicle is determined according to the first position corresponding to each target road element acquired by the target vehicle and the camera calibration file corresponding to the target vehicle. The second position corresponding to a target road element is a position of the target road element relative to the target vehicle, and the camera calibration file includes an internal reference calibration file and an external reference calibration file. The position of each target road element relative to the preset camera of the target vehicle may be determined according to the first position corresponding to the target road element and the internal reference calibration file, and the second position corresponding to each target road element may be determined according to the position of the target road element relative to the preset camera of the target vehicle and the external reference calibration file. Finally, the collection element position information corresponding to each target road element acquired by the target vehicle is determined according to the second position corresponding to the target road element acquired by the target vehicle and the shooting position information corresponding to the target road element image.

Through the above method, the cloud serve may determine the collection element position information and the collection element attribute corresponding to each target road element acquired by each target vehicle.

(2) The original confidence value corresponding to the target road section is updated in the high-precision map according to the collection element position information and the collection element attribute corresponding to each target road element required by each target vehicle.

In embodiments of the present disclosure, after determining the collection element position information and the collection element attribute corresponding to each target road element acquired by each target vehicle according to the target road element images corresponding to the target vehicle, the shooting position information corresponding to each target road element image and the camera calibration file, the cloud server may update the original confidence value corresponding to the target road section in the high-precision map according to the collection element position information and the collection element attribute corresponding to each target road element required by each target vehicle.

Specifically, in this step, the cloud server may update the original confidence value corresponding to the target road section in the high-precision map according to the collection element position information and the collection element attribute corresponding to each target road element required by each target vehicle through the following manner. Firstly, original element position information, an original element attribute and an original confidence value corresponding to each target road element are required from the high-precision map. Then, the collection element position information and the collection element attribute corresponding to each target road element are compared with the original element position information and the original element attribute corresponding to the target road element to determine pieces of second comparison result information corresponding to the target road element. If the collection element position information corresponding to a certain target road element acquired by a certain target vehicle is the same as the original element position information corresponding to the target road element, and the collection element attribute corresponding to the target road element acquired by the target vehicle is the same as the original element attribute corresponding to the target road element, it is determined that the second comparison result information corresponding to the target road element acquired by the target vehicle is correct comparison result information. If the collection element position information corresponding to a certain target road element acquired by a certain target vehicle is different from the original element position information corresponding to the target road element, or the collection element attribute corresponding to the target road element acquired by the target vehicle is different from the original element attribute corresponding to the target road element, it is determined that the second comparison result information corresponding to the target road element acquired by the target vehicle is error comparison result information. For any target road element, if a proportion of the number of pieces of error comparison result information in the pieces of second comparison result information corresponding to the target road element to the number of the pieces of second comparison result information is greater than a preset proportion threshold, a first preset confidence threshold corresponding to the target road element is subtracted from the original confidence value corresponding to the target road element to obtain an updated confidence value corresponding to the target road element. The preset proportion threshold may be, but not limited to, 30%, 40%, 50% and so on, and the first preset confidence thresholds corresponding to different types of target road elements may be the same or different, which are not particularly limited in embodiments of the present disclosure. For example, the preset proportion threshold is 40%, the original confidence value corresponding to a target lane line A is 6.4, the first preset confidence threshold corresponding to the target lane line A is 0.05, and it is determined according to the confidence updating data packets acquired by 100 target vehicles that the number of the pieces of error comparison result information in 100 pieces of second comparison result information corresponding to the target lane line A is 57, so the proportion of the number of the pieces of error comparison result information corresponding to the target lane line A to the number of the pieces of respective second comparison result information is 57%, which is greater than the preset proportion threshold 40%. In this case, the first preset confidence threshold corresponding to the target lane line A is subtracted from the original confidence value corresponding to the target lane line A to obtain the updated confidence value (=6.4−0.05=6.35) corresponding to the target lane line A. Finally, when the updated confidence value corresponding to each target road element is acquired, the first updated confidence value corresponding to the target road section may be determined according to the updated confidence value corresponding to each target road element, and the original confidence value corresponding to the target road section is updated in the high-precision map using the first updated confidence value corresponding to the target road section. Specifically, a weighted value corresponding to each target road element may be acquired first, then a weighted sum of the updated confidence values corresponding to the plurality of target road elements may be computed according to the weighted value corresponding to each target road element, and the computation result may be determined as the first updated confidence value corresponding to the target road section, but the present disclosure is not limited thereto.

Specifically, in this step, the cloud server may update the original confidence value corresponding to the target road section in the high-precision map according to the collection element position information and the collection element attribute corresponding to each target road element required by each target vehicle through the following manner. Firstly, original element position information, an original element attribute and an original confidence value corresponding to each target road element are required from the high-precision map. Then, the collection element position information and the collection element attribute corresponding to each target road element are compared with the original element position information and the original element attribute corresponding to the target road element to determine pieces of second comparison result information corresponding to the target road element. If the collection element position information corresponding to a certain target road element acquired by a certain target vehicle is the same as the original element position information corresponding to the target road element, and the collection element attribute corresponding to the target road element acquired by the target vehicle is the same as the original element attribute corresponding to the target road element, it is determined that the second comparison result information corresponding to the target road element acquired by the target vehicle is correct comparison result information. If the collection element position information corresponding to a certain target road element acquired by a certain target vehicle is different from the original element position information corresponding to the target road element, or the collection element attribute corresponding to the target road element acquired by the target vehicle is different from the original element attribute corresponding to the target road element, it is determined that the second comparison result information corresponding to the target road element acquired by the target vehicle is error comparison result information. For any target road element, the number of pieces of error comparison result information corresponding to the target road element is determined according to the pieces of second comparison result information corresponding to the target road element, and a product of a second preset confidence threshold and the number of the pieces of error comparison result information corresponding to the target road element is subtracted from an original confidence value corresponding to the target road element to obtain an updated confidence value corresponding to the target road element, i.e., the updated confidence value corresponding to the target road element=the original confidence value corresponding to the target road element−(the second preset confidence threshold corresponding to the target road element*the number of the pieces of error comparison result information corresponding to the target road element). The second preset confidence thresholds corresponding to different types of target road elements may be the same or different, which are not particularly limited in embodiments of the present disclosure. For example, the original confidence value corresponding to a target lane line A is 6.4, the second preset confidence threshold corresponding to the target lane line A is 0.001, and it is determined according to the confidence updating data packets acquired by 100 target vehicles that the number of the pieces of error comparison result information in 100 pieces of second comparison result information corresponding to the target lane line A is 49, a product of the second preset confidence threshold and the number of the pieces of error comparison result information corresponding to the target lane line A is subtracted from the original confidence value corresponding to the target lane line A to obtain the updated confidence value (=6.4−0.001*49=6.351) corresponding to the target lane line A. Finally, when the updated confidence value corresponding to each target road element is acquired, the first updated confidence value corresponding to the target road section may be determined according to the updated confidence value corresponding to each target road element, and the original confidence value corresponding to the target road section is updated in the high-precision map using the first updated confidence value corresponding to the target road section. Specifically, a weighted value corresponding to each target road element may be acquired first, then a weighted sum of the updated confidence values corresponding to the plurality of target road elements may be computed according to the weighted value corresponding to each target road element, and the computation result is determined as the first updated confidence value corresponding to the target road section, but the present disclosure is not limited thereto.

In embodiments of the present disclosure, in parallel to the step 202a, a step 202b may be performed, in which the original confidence value corresponding to the target road section is updated in the high-precision map according to the pieces of first comparison result information corresponding to each target vehicle.

In embodiments of the present disclosure, when the confidence updating data packet uploaded by each target vehicle includes the first comparison result information corresponding to each target road element, the cloud server may update the original confidence value corresponding to the target road section in the high-precision map according to pieces of first comparison result information corresponding to each target vehicle.

Specifically, in embodiments of the present disclosure, the cloud server may update the original confidence value corresponding to the target road section in the high-precision map according to the pieces of first comparison result information corresponding to each target vehicle through the following manner. Firstly, for any target road element, if a proportion of the number of pieces of error comparison result information in the pieces of first comparison result information corresponding to the target road element to the number of the pieces of first comparison result information is greater than a preset proportion threshold, a first preset confidence threshold corresponding to the target road element is subtracted from the original confidence value corresponding to the target road element to obtain an updated confidence value corresponding to the target road element. The preset proportion threshold may be, but not limited to, 30%, 40%, 50% and so on, and the first preset confidence thresholds corresponding to different types of target road elements may be the same or different, which are not particularly limited in embodiments of the present disclosure. Then, when the updated confidence value corresponding to each target road element is acquired, the first updated confidence value corresponding to the target road section may be determined according to the updated confidence value corresponding to each target road element, and the original confidence value corresponding to the target road section is updated in the high-precision map using the first updated confidence value corresponding to the target road section. Specifically, a weighted value corresponding to each target road element may be acquired first, then a weighted sum of the updated confidence values corresponding to the plurality of target road elements may be computed according to the weighted value corresponding to each target road element, and the computation result is determined as the first updated confidence value corresponding to the target road section, but the present disclosure is not limited thereto.

Specifically, in embodiments of the present disclosure, the cloud server may update the original confidence value corresponding to the target road section in the high-precision map according to the pieces of first comparison result information corresponding to each target vehicle through the following manner. Firstly, for any target road element, the number of pieces of error comparison result information corresponding to the target road element is determined according to the pieces of first comparison result information corresponding to the target road element, and a product of a second preset confidence threshold and the number of the pieces of error comparison result information corresponding to the target road element is subtracted from an original confidence value corresponding to the target road element to obtain an updated confidence value corresponding to the target road element, i.e., the updated confidence value corresponding to the target road element=the original confidence value corresponding to the target road element−(the second preset confidence threshold corresponding to the target road element*the number of the pieces of error comparison result information corresponding to the target road element). The second preset confidence thresholds corresponding to different types of target road elements may be the same or different, which are not particularly limited in embodiments of the present disclosure. Then, when the updated confidence value corresponding to each target road element is acquired, the first updated confidence value corresponding to the target road section may be determined according to the updated confidence value corresponding to each target road element, and the original confidence value corresponding to the target road section is updated in the high-precision map using the first updated confidence value corresponding to the target road section. Specifically, a weighted value corresponding to each target road element may be acquired first, then a weighted sum of the updated confidence values corresponding to the plurality of target road elements may be computed according to the weighted value corresponding to each target road element, and the computation result is determined as the first updated confidence value corresponding to the target road section, but the present disclosure is not limited thereto.

It should be illustrated that, in an actual application, for any target vehicle, it may adopt the method as described in the steps 202a (1)-(2) to determine the collection element position information and the collection element attribute corresponding to each target road element according to the target road element image corresponding to each target road element acquired by the target vehicle itself, the shooting position information corresponding to each target road element image and the camera calibration file corresponding to the target vehicle itself, and compare the collection element position information and the collection element attribute corresponding to each target road element with the original element position information and the original element attribute corresponding to the target road element recorded in the high-precision map to determine the first comparison result information corresponding to the target road element, and finally upload the confidence updating data packet including the first comparison result information corresponding to each target road element to the cloud server. However, embodiments of the present disclosure are not limited thereto.

In embodiments of the present disclosure, after the step 202a or 202b, a step 203 is performed, in which the first updated confidence value corresponding to the target road section is transmitted the target vehicles and other vehicles to enable the target vehicles and the other vehicles to select an automatic driving mode according to the first updated confidence value when they pass through the target road section.

In embodiments of the present disclosure, after updating the original confidence value corresponding to the target road section in the high-precision map according to the target road element images corresponding to each target vehicle, the shooting position information corresponding to each target road element image and the camera calibration file, or updating the original confidence value corresponding to the target road section in the high-precision map according to the pieces of first comparison result information corresponding to each target vehicle, the cloud server further needs to transmit the first updated confidence value corresponding to the target road section to the target vehicles or other vehicles to enable the target vehicles or the other vehicles to select an automatic driving mode according to the first updated confidence value corresponding to the target road section when they pass through the target road section.

Further, in embodiments of the present disclosure, if the cloud server does not receive the confidence updating data packet corresponding to the target road section within a preset time period, the cloud server may subtracts a third preset confidence threshold from the original confidence value corresponding to the target road section to obtain a second updated confidence value corresponding to the target road element, and use the second updated confidence value corresponding to the target road section to update the original confidence value corresponding to the target road section in the high-precision map. The preset time period may be, but not limited to, 24 hours, 48 hours, 72 hours and so on.

In order to achieve the above objectives, in another aspect of the present disclosure, embodiments of the present disclosure provide a storage medium having stored therein instructions that, when executed, control a device in which the storage medium is disposed to execute the method for updating a confidence of a high-precision map as described hereinbefore.

In order to achieve the above objectives, in another aspect of the present disclosure, embodiments of the present disclosure provide an apparatus for updating a confidence of a high-precision map. The device include: a storage medium; and one or more processors coupled to the storage medium. The one or more processors are configured to execute program instructions stored in the storage medium, and the program instructions, when executed, cause the method for updating a confidence of a high-precision map as described hereinbefore to be performed.

Further, as an implementation of the above methods as shown in FIG. 1 and FIG. 2, another embodiment of the present application also provides an apparatus for updating a confidence of a high-precision map. Embodiments with respect to the apparatus correspond to above embodiments with respect to the method. For ease of reading, details that have been described in above embodiments with respect to the method will not be elaborated in embodiments with respect to the apparatus, but it is clear that the apparatus as described herein is able to realize all the contents as described in above embodiments with respect to the method. The apparatus is applied to reduce the cost for updating the confidence value of the high-precision map, on the basis of ensuring that confidence values corresponding to respective road sections in the high-precision map are updated in time. Specifically, as shown in FIG. 3, the apparatus includes an acquiring unit 31, a first updating unit 32 or a second updating unit 33.

The acquiring unit 31 is configured to acquire confidence updating data packets corresponding to target vehicles. The confidence updating data packets corresponding to target vehicles are confidence updating data packets uploaded to a cloud server when each of target vehicles passes through a target road section within a target time period, the target road section includes a plurality of target road elements, the confidence updating data packets include target road element images corresponding to each of the target road elements, shooting position information corresponding to each of the target road element images and a camera calibration file, or the confidence updating data packets include pieces of first comparison result information corresponding to each of the target road elements.

The first updating unit 32 is configured to update an original confidence value corresponding to the target road section in the high-precision map according to the target road element images corresponding to each of the target vehicles, the shooting position information corresponding to each of the target road element images and the camera calibration file, when the confidence updating data packet corresponding to the target vehicle includes the target road element image corresponding to each of the target road elements, the shooting position information corresponding to each of the target road element images and the camera calibration file.

The second updating unit 33 is configured to update the original confidence value corresponding to the target road section in the high-precision map according to the pieces of first comparison result information corresponding to each of the target vehicles, when the confidence updating data packet corresponding to the target vehicle includes the pieces of first comparison result information corresponding to each of the target road elements.

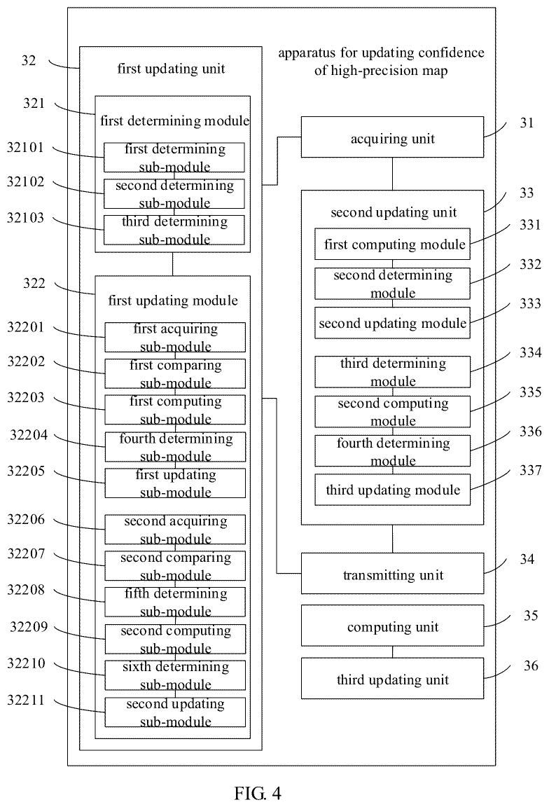

Further, as shown in FIG. 4, the first updating unit 32 includes a first determining module 321 and a first updating module 322.

The first determining module 321 is configured to determine collection element position information and a collection element attribute corresponding to each of the target road elements acquired by each of the target vehicles according to the target road element images corresponding to each of the target vehicles, the shooting position information corresponding to each of the target road element images and the camera calibration file. The collection element position information corresponding to the target road element is position information of the target road element relative to the high-precision map.

The first updating module 322 is configured to update the original confidence value corresponding to the target road section in the high-precision map according to the collection element position information and the collection element attribute corresponding to each of the target road elements acquired by each of the target vehicles.

Further, as shown in FIG. 4, the first determining module 321 includes: a first determining sub-module 32101, a second determining sub-module 32102, and a third determining sub-module 32103.

The first determining sub-module 32101 is configured to determine a first position and the collection element attribute corresponding to each of the target road elements acquired by the target vehicle according to a preset perceptual recognition algorithm and the target road element images corresponding to the target vehicle. The first position corresponding to the target road element is a position of the target road element in the respective target road element image.

The second determining sub-module 32102 is configured to determine a second position corresponding to each of the target road elements acquired by the target vehicle according to the first position corresponding to each of the target road elements acquired by the target vehicle and the camera calibration file corresponding to the target vehicle. The second position corresponding to the target road element is a position of the target road element relative to the target vehicle.

The third determining sub-module 32103 is configured to determine the collection element position information corresponding to each of the target road elements acquired by the target vehicle according to the second position corresponding to each of the target road elements acquired by the target vehicle and the shooting position information corresponding to each of the target road element images.

Further, as shown in FIG. 4, the first updating module 322 includes: a first acquiring sub-module 32201, a first comparing sub-module 32202, a first computing sub-module 32203, a fourth determining sub-module 32204 and a first updating sub-module 32205.

The first acquiring sub-module 32201 is configured to acquire original element position information, an original element attribute and an original confidence value corresponding to each of the target road elements from the high-precision map.

The first comparing sub-module 32202 is configured to compare the collection element position information and the collection element attribute corresponding to each of the target road elements acquired by each of the target vehicles with the original element position information and the original element attribute corresponding to each of the target road elements, respectively, to obtain pieces of second comparison result information corresponding to each of the target road elements.

The first computing sub-module 32203 is configured to subtract a first preset confidence threshold corresponding to a target road element from the original confidence value corresponding to the target road element to obtain an updated confidence value corresponding to the target road element, when a proportion of the number of pieces of error comparison result information in the pieces of second comparison result information corresponding to the target road element to the number of the pieces of second comparison result information is greater than a preset proportion threshold.

The fourth determining sub-module 32204 is configured to determine a first updated confidence value corresponding to the target road section according to the updated confidence value corresponding to each of the target road elements.

The first updating sub-module 32205 is configured to update the original confidence value corresponding to the target road section in the high-precision map using the first updated confidence value corresponding to the target road section.

Further, as shown in FIG. 4, the first updating module 322 further includes: a second acquiring sub-module 32206, a second comparing sub-module 32207, a fifth determining sub-module 32208, a second computing sub-module 32209, a sixth determining sub-module 32210 and a second updating sub-module 32211.

The second acquiring sub-module 32206 is configured to acquire original element position information, an original element attribute and an original confidence value corresponding to each of the target road elements from the high-precision map.

The second comparing sub-module 32207 is configured to compare the collection element position information and the collection element attribute corresponding to each of the target road elements acquired by each of the target vehicles with the original element position information and the original element attribute corresponding to each of the target road elements, respectively, to obtain pieces of second comparison result information corresponding to each of the target road elements.

The fifth determining sub-module 32208 is configured to determine the number of pieces of error comparison result information corresponding to the target road element according to the pieces of second comparison result information corresponding to the target road element.

The second computing sub-module 32209 is configured to obtain an updated confidence value corresponding to the target road element by subtracting a product of a second preset confidence threshold and the number of the pieces of error comparison result information corresponding to the target road element from the original confidence value corresponding to the target road element.

The sixth determining sub-module 32210 is configured to determine a first updated confidence value corresponding to the target road section according to the updated confidence value corresponding to each of the target road elements.

The second updating sub-module 32211 is configured to update the original confidence value corresponding to the target road section in the high-precision map using the first updated confidence value corresponding to the target road section.

Further, as shown in FIG. 4, the second updating unit 33 includes: a first computing module 331, a second determining module 332 and a second updating module 333.

The first computing module 331 is configured to subtract a first preset confidence threshold corresponding to the target road element from an original confidence value corresponding to the target road element to obtain an updated confidence value corresponding to the target road element, when a proportion of the number of pieces of error comparison result information in the pieces of first comparison result information corresponding to the target road element to the number of the pieces of first comparison result information is greater than a preset proportion threshold.

The second determining module 332 is configured to determine a first updated confidence value corresponding to the target road section according to the updated confidence value corresponding to each of the target road elements.

The second updating module 333 is configured to update the original confidence value corresponding to the target road section in the high-precision map using the first updated confidence value corresponding to the target road section.

Further, as shown in FIG. 4, the second updating unit 33 further includes: a third determining module 334, a second computing module 335, a fourth determining module 336 and a third updating module 337.

The third determining module 334 is configured to determine the number of pieces of error comparison result information corresponding to the target road element according to the pieces of first comparison result information corresponding to the target road element.

The second computing module 335 is configured to obtain an updated confidence value corresponding to the target road element by subtracting a product of a second preset confidence threshold and the number of pieces of error comparison result information corresponding to the target road element from an original confidence value corresponding to the target road element.

The fourth determining module 336 is configured to determine a first updated confidence value corresponding to the target road section according to the updated confidence value corresponding to each of the target road elements.

The third updating module 337 is configured to update the original confidence value corresponding to the target road section in the high-precision map using the first updated confidence value corresponding to the target road section.

Further, as shown in FIG. 4, the apparatus further includes a transmitting unit 34.

The transmitting unit 34 is configured to transmit the first updated confidence value corresponding to the target road section to the target vehicles or other vehicles to enable the target vehicles or the other vehicles to select an automatic driving mode according to the first updated confidence value corresponding to the target road section in passing through the target road section, after the first updating unit 32 updates the original confidence value corresponding to the target road section in the high-precision map according to the target road element images corresponding to each of the target vehicles, the shooting position information corresponding to each of the target road element images and the camera calibration file, or after the second updating unit 33 updates the original confidence value corresponding to the target road section in the high-precision map according to the pieces of first comparison result information corresponding to each of the target vehicles.

Further, as shown in FIG. 4, the apparatus further includes a computing unit 35 and a third updating unit 36.

The computing unit 35 is configured to subtract a third preset confidence threshold from the original confidence value corresponding to the target road section to obtain a second updated confidence value corresponding to the target road section, in response to receiving no confidence updating data packet corresponding to the target road section within a preset time period.

The third updating unit 36 is configured to update the original confidence value corresponding to the target road section in the high-precision map using the second updated confidence value corresponding to the target road section.

Embodiments of the present disclosure provide a method and apparatus for updating the confidence of a high-precision map. In contrast to updating the confidence values corresponding to respective road sections in a high-precision map by a centralized drawing method in the related art, embodiments of the present disclosure are able to acquire, at the cloud server, the confidence updating data packets (including the target road element image corresponding to each target road element in the target road section, the shooting position information corresponding to each target road element image and the camera calibration file corresponding to the respective target vehicle, or including pieces of first comparison result information corresponding to each target road element) acquired by target vehicles when each of the target vehicles passes through the target road section within the target time period, and update, by the cloud server, the original confidence value corresponding to the target road section in the high-precision map according to the target road element images corresponding to each target vehicle, the shooting position information corresponding to each target road element image and the camera calibration file, or update, by the cloud server, the original confidence value corresponding to the target road section in the high-precision map according to the pieces of first comparison result information corresponding to each target vehicle. Since each target vehicle is an ordinary vehicle equipped with a preset camera and a GPS sensor, and the target vehicle, after acquiring the confidence updating data packet, will upload the confidence updating data packet to the cloud server, the cloud server can ensure that the confidence values corresponding to respective road sections in the high-precision map are updated in time, and at the same time, the cost for updating the confidence value of the high-precision map is reduced.

The apparatus for updating the confidence of a high-precision map includes a memory and a processor. The above acquiring unit, the first updating unit and the second updating unit are stored in the memory as program units, and the processor is configured to execute the program units stored in the memory to realize the corresponding functions.

The processor includes a kernel, which is configured to call a program unit from the memory. The processor may include one or more kernels. By adjusting parameters of the kernel, it can be ensured that the confidence values corresponding to respective road sections in the high-precision map are updated in time, and at the same time, the cost for updating the confidence value of the high-precision map is reduced.

Embodiments of the present disclosure provide a storage medium having stored therein instructions that, when executed, control a device in which the storage medium is disposed to execute the method for updating a confidence of a high-precision map as described hereinbefore.

The storage medium may include a non-permanent memory, a random access memory (RAM) and/or a nonvolatile memory and other forms in the computer-readable medium, such as a read-only memory (ROM) or a flash memory (such as a flash RAM), and the memory includes at least one storage chip.

Embodiments of the present disclosure further provide an apparatus for updating a confidence of a high-precision map, which includes: a storage medium; and one or more processors coupled to the storage medium. The one or more processors are configured to execute program instructions stored in the storage medium, and the program instructions, when executed, cause the method for updating a confidence of a high-precision map as described hereinbefore to be performed.

Embodiments of the present disclosure provide a device. The device includes a processor, a memory and a program stored in the memory and executable by the processor. The processor, when executes the program, causes the following steps to be achieved:
acquiring confidence updating data packets corresponding to target vehicles, wherein the confidence updating data packets corresponding to target vehicles are confidence updating data packets uploaded to a cloud server when each of target vehicles passes through a target road section within a target time period, the target road section includes a plurality of target road elements, the confidence updating data packets include target road element images corresponding to each of the target road elements, shooting position information corresponding to each of the target road element images and a camera calibration file, or the confidence updating data packets include pieces of first comparison result information corresponding to each of the target road elements;
updating an original confidence value corresponding to the target road section in the high-precision map according to the target road element images corresponding to each of the target vehicles, the shooting position information corresponding to each of the target road element images and the camera calibration file; or
updating the original confidence value corresponding to the target road section in the high-precision map according to the pieces of first comparison result information corresponding to each of the target vehicles.

Further, the updating the original confidence value corresponding to the target road section in the high-precision map according to the target road element images corresponding to each of the target vehicles, the shooting position information corresponding to each of the target road element images and the camera calibration file includes:
determining collection element position information and a collection element attribute corresponding to each of the target road elements acquired by each of the target vehicles according to the target road element images corresponding to each of the target vehicles, the shooting position information corresponding to each of the target road element images and the camera calibration file, wherein the collection element position information corresponding to each of the target road elements is position information of the target road element relative to the high-precision map; and
updating the original confidence value corresponding to the target road section in the high-precision map according to the collection element position information and the collection element attribute corresponding to each of the target road elements acquired by each of the target vehicles.

Further, the determining the collection element position information and the collection element attribute corresponding to each of the target road elements acquired by each of the target vehicles according to the target road element images corresponding to each of the target vehicles, the shooting position information corresponding to each of the target road element images and the camera calibration file includes:
determining a first position and the collection element attribute corresponding to each of the target road elements acquired by the target vehicle according to a preset perceptual recognition algorithm and the target road element images corresponding to the target vehicle, wherein the first position corresponding to the target road element is a position of the target road element in the respective target road element image;
determining a second position corresponding to each of the target road elements acquired by the target vehicle according to the first position corresponding to each of the target road elements acquired by the target vehicle and the camera calibration file corresponding to the target vehicle, wherein the second position corresponding to the target road element is a position of the target road element relative to the target vehicle; and
determining the collection element position information corresponding to each of the target road elements acquired by each of the target vehicles according to the second position corresponding to each of the target road elements acquired by the target vehicle and the shooting position information corresponding to each of the target road element images.

Further, the updating the original confidence value corresponding to the target road section in the high-precision map according to the collection element position information and the collection element attribute corresponding to each of the target road elements acquired by each of the target vehicles includes:
acquiring original element position information, an original element attribute and an original confidence value corresponding to each of the target road elements from the high-precision map;
comparing the collection element position information and the collection element attribute corresponding to each of the target road elements acquired by each of the target vehicles with the original element position information and the original element attribute corresponding to each of the target road elements, respectively, to obtain pieces of second comparison result information corresponding to each of the target road elements;
subtracting a first preset confidence threshold corresponding to a target road element from the original confidence value corresponding to the target road element to obtain an updated confidence value corresponding to the target road element, when a proportion of the number of pieces of error comparison result information in the pieces of second comparison result information corresponding to the target road element to the number of the pieces of second comparison result information is greater than a preset proportion threshold;
determining a first updated confidence value corresponding to the target road section according to the updated confidence value corresponding to each of the target road elements; and
updating the original confidence value corresponding to the target road section in the high-precision map using the first updated confidence value corresponding to the target road section.

Further, the updating the original confidence value corresponding to the target road section in the high-precision map according to the collection element position information and the collection element attribute corresponding to each of the target road elements acquired by each of the target vehicles includes:
acquiring original element position information, an original element attribute and an original confidence value corresponding to each of the target road elements from the high-precision map;
comparing the collection element position information and the collection element attribute corresponding to each of the target road elements acquired by each of the target vehicles with the original element position information and the original element attribute corresponding to each of the target road elements, respectively, to obtain pieces of second comparison result information corresponding to each of the target road elements;
determining the number of pieces of error comparison result information corresponding to the target road element according to the pieces of second comparison result information corresponding to the target road element;
obtaining an updated confidence value corresponding to the target road element by subtracting a product of a second preset confidence threshold and the number of the pieces of error comparison result information corresponding to the target road element from the original confidence value corresponding to the target road element;
determining a first updated confidence value corresponding to the target road section according to the updated confidence value corresponding to each of the target road elements; and
updating the original confidence value corresponding to the target road section in the high-precision map using the first updated confidence value corresponding to the target road section.

Further, the updating the original confidence value corresponding to the target road section in the high-precision map according to the pieces of first comparison result information corresponding to each of the target vehicles includes:
subtracting a first preset confidence threshold corresponding to the target road element from an original confidence value corresponding to the target road element to obtain an updated confidence value corresponding to the target road element, when a proportion of the number of pieces of error comparison result information in the pieces of first comparison result information corresponding to the target road element to the number of the pieces of first comparison result information is greater than a preset proportion threshold;
determining a first updated confidence value corresponding to the target road section according to the updated confidence value corresponding to each of the target road elements; and
updating the original confidence value corresponding to the target road section in the high-precision map using the first updated confidence value corresponding to the target road section.

Further, the updating the original confidence value corresponding to the target road section in the high-precision map according to the pieces of first comparison result information corresponding to each of the target vehicles includes:
determining the number of pieces of error comparison result information corresponding to the target road element according to the pieces of first comparison result information corresponding to the target road element;
obtaining an updated confidence value corresponding to the target road element by subtracting a product of a second preset confidence threshold and the number of pieces of error comparison result information corresponding to the target road element from an original confidence value corresponding to the target road element;
determining a first updated confidence value corresponding to the target road section according to the updated confidence value corresponding to each of the target road elements; and
updating the original confidence value corresponding to the target road section in the high-precision map using the first updated confidence value corresponding to the target road section.

Further, after updating the original confidence value corresponding to the target road section in the high-precision map according to the target road element images corresponding to each of the target vehicles, the shooting position information corresponding to each of the target road element images and the camera calibration file; or updating the original confidence value corresponding to the target road section in the high-precision map according to the pieces of first comparison result information corresponding to each of the target vehicles, the method further includes:
transmitting the first updated confidence value corresponding to the target road section to the target vehicles or other vehicles to enable the target vehicles or the other vehicles to select an automatic driving mode according to the first updated confidence value corresponding to the target road section in passing through the target road section.

Further, the method further includes:
subtracting a third preset confidence threshold from the original confidence value corresponding to the target road section to obtain a second updated confidence value corresponding to the target road element, in response to receiving no confidence updating data packet corresponding to the target road section within a preset time period; and
updating the original confidence value corresponding to the target road section in the high-precision map using the second updated confidence value corresponding to the target road section.

Embodiments of the present disclosure further provide a computer program product that, when executed on a data processing device, is suitable for executing program codes that are initialized with the following method steps: acquiring confidence updating data packets corresponding to target vehicles, wherein the confidence updating data packets corresponding to target vehicles are confidence updating data packets uploaded to a cloud server when each of target vehicles passes through a target road section within a target time period, the target road section includes a plurality of target road elements, the confidence updating data packets include target road element images corresponding to each of the target road elements, shooting position information corresponding to each of the target road element images and a camera calibration file, or the confidence updating data packets include pieces of first comparison result information corresponding to each of the target road elements; updating an original confidence value corresponding to the target road section in the high-precision map according to the target road element images corresponding to each of the target vehicles, the shooting position information corresponding to each of the target road element images and the camera calibration file; or updating the original confidence value corresponding to the target road section in the high-precision map according to the pieces of first comparison result information corresponding to each of the target vehicles.

It will be understood by those skilled in the art that embodiments of the present disclosure may be provided as methods, systems, or computer program products. Therefore, embodiments of the present disclosure may be implemented in a form of hardware, software or a combination thereof. Moreover, embodiments of the present disclosure may adopt a form of the computer program product executable on one or more computer available storage mediums (including but not limited to disk memories, CD-ROMs, optical memories, etc.) contained therein computer available program code.

The present disclosure is described with reference to the flowcharts and/or block diagrams of the method, device (system) and computer program product according to embodiments of the present disclosure. It should be understood that each process and/or block in the flowcharts and/or block diagrams as well as any combination of processes and/or blocks in the flowcharts and/or block diagrams may be realized by computer program instructions. These computer program instructions may be provided to a processor of a general-purpose computer, a special-purpose computer, an embedded processing machine or other programmable data processing devices to generate a machine, so that an apparatus for realizing one or more functions specified in one or more processes in the flowcharts and/or one or more blocks in the block diagrams is generated through the instructions executed by the processor of the computers or other programmable data processing devices.

These computer program instructions may also be stored in a computer-readable memory that can guide the computer or other programmable data processing device to work in a specific way, so that the instructions stored in the computer-readable memory form a manufactured product including an instruction device, which implements the one or more functions specified in one or more processes in the flowcharts and/or one or more blocks in the block diagrams.

These computer program instructions may also be loaded on a computer or other programmable data processing device, so that a series of operation steps are performed on the computer or other programmable device to produce computer implemented processing, so that the instructions executed on the computer or other programmable device provide steps for realizing the one or more functions specified in one or more processes of the flowchart and/or one or more blocks in the block diagrams.

In a typical configuration, a computing device includes one or more processors (CPUs), input/output interfaces, a network interface, and a memory.

The memory may include a non-permanent memory, a random access memory (RAM) and/or a nonvolatile memory and other forms in the computer-readable medium, such as a read-only memory (ROM) or a flash memory (such as a flash RAM) and the memory is an example of the computer-readable medium.

The computer-readable medium include permanent and non-permanent, removable and non-removable media, which may realize information storage by any method or technology. The information may be computer-readable instructions, data structures, modules of programs or other data. Examples of the computer storage medium include, but are not limited to, phase-change memory (such as a parallel random access machine, PRAM), a static random access memory (SRAM), a dynamic random access memory (DRAM), other types of random access memory (RAMs), a read-only memory (ROM), an electrically erasable programmable read-only memory (EEPROM), a flash memory or other memory technology, a portable compact disk read-only memory (CD-ROM), a digital versatile disc (DVD) or other optical storage, a cartridge-form magnetic tape, a magnetic tape, a magnetic disk storage or other magnetic storage devices or any other non-transmission medium, which may be used to store information that is accessible by a computing device. As defined herein, the computer-readable medium does not include temporary computer-readable media (transitory media), such as modulated data signals and carriers.

Also, it should be noted that the terms “comprise”, “include” or any other variations thereof are intended to cover non-exclusive inclusion, so that a process, method, commodity or device including a series of elements includes not only those elements, but also other elements not explicitly listed, or elements inherent in such process, method, commodity or device. In the absence of more restrictions, elements defined by the statement “including a . . . ” do not exclude the existence of other identical elements in the process, method, commodity or device including these elements.

It will be understood by those skilled in the art that embodiments of the present disclosure may be provided as methods, systems, or computer program products. Therefore, embodiments of the present disclosure may be implemented in a form of hardware, software or a combination thereof. Moreover, embodiments of the present disclosure may adopt a form of the computer program product executable on one or more computer available storage mediums (including but not limited to disk memories, CD-ROMs, optical memories, etc.) contained therein computer available program code.

The above described embodiments are only examples of the present disclosure, which shall not be construed to limit the present disclosure. It will be appreciated by those skilled in the art that, the present disclosure may cover various changes and modifications, and any modifications, equivalents, improvements made within the spirit and principle of the present disclosure shall be included in the scope of the present disclosure as defined in claims.

1. A method for updating a confidence of a high-precision map, comprising:
acquiring confidence updating data packets corresponding to target vehicles, wherein the confidence updating data packets corresponding to the target vehicles are confidence updating data packets uploaded to a cloud server when each of the target vehicles passes through a target road section within a target time period, the target road section comprises a plurality of target road elements, the confidence updating data packets comprise target road element images corresponding to each of the target road elements, shooting position information corresponding to each of the target road element images and a camera calibration file, or the confidence updating data packets comprise pieces of first comparison result information corresponding to each of the target road elements;
updating an original confidence value corresponding to the target road section in the high-precision map according to the target road element images corresponding to each of the target vehicles, the shooting position information corresponding to each of the target road element images and the camera calibration file; or
updating the original confidence value corresponding to the target road section in the high-precision map according to the pieces of first comparison result information corresponding to each of the target vehicles.

2. The method according to claim 1, wherein updating the original confidence value corresponding to the target road section in the high-precision map according to the target road element images corresponding to each of the target vehicles, the shooting position information corresponding to each of the target road element images and the camera calibration file comprises:
determining collection element position information and a collection element attribute corresponding to each of the target road elements acquired by each of the target vehicles according to the target road element images corresponding to each of the target vehicles, the shooting position information corresponding to each of the target road element images and the camera calibration file, wherein the collection element position information corresponding to each of the target road elements is position information of the target road element relative to the high-precision map; and
updating the original confidence value corresponding to the target road section in the high-precision map according to the collection element position information and the collection element attribute corresponding to each of the target road elements acquired by each of the target vehicles.

3. The method according to claim 2, wherein determining the collection element position information and the collection element attribute corresponding to each of the target road elements acquired by each of the target vehicles according to the target road element images corresponding to each of the target vehicles, the shooting position information corresponding to each of the target road element images and the camera calibration file comprises:
determining a first position and the collection element attribute corresponding to each of the target road elements acquired by the target vehicle according to a preset perceptual recognition algorithm and the target road element images corresponding to the target vehicle, wherein the first position corresponding to the target road element is a position of the target road element in a respective target road element image;
determining a second position corresponding to each of the target road elements acquired by the target vehicle according to the first position corresponding to each of the target road elements acquired by the target vehicle and the camera calibration file corresponding to the target vehicle, wherein the second position corresponding to the target road element is a position of the target road element relative to the target vehicle; and
determining the collection element position information corresponding to each of the target road elements acquired by each of the target vehicles according to the second position corresponding to each of the target road elements acquired by the target vehicle and the shooting position information corresponding to each of the target road element images.

4. The method according to claim 2, wherein updating the original confidence value corresponding to the target road section in the high-precision map according to the collection element position information and the collection element attribute corresponding to each of the target road elements acquired by each of the target vehicles comprises:
acquiring original element position information, an original element attribute and an original confidence value corresponding to each of the target road elements from the high-precision map;
comparing the collection element position information and the collection element attribute corresponding to each of the target road elements acquired by each of the target vehicles with the original element position information and the original element attribute corresponding to each of the target road elements, respectively, to obtain pieces of second comparison result information corresponding to each of the target road elements;
subtracting a first preset confidence threshold corresponding to a target road element from the original confidence value corresponding to the target road element to obtain an updated confidence value corresponding to the target road element, when a proportion of the number of pieces of error comparison result information in the pieces of second comparison result information corresponding to the target road element to the number of the pieces of second comparison result information is greater than a preset proportion threshold;
determining a first updated confidence value corresponding to the target road section according to the updated confidence value corresponding to each of the target road elements; and
updating the original confidence value corresponding to the target road section in the high-precision map using the first updated confidence value corresponding to the target road section.

5. The method according to claim 2, wherein updating the original confidence value corresponding to the target road section in the high-precision map according to the collection element position information and the collection element attribute corresponding to each of the target road elements acquired by each of the target vehicles comprises:
acquiring original element position information, an original element attribute and an original confidence value corresponding to each of the target road elements from the high-precision map;
comparing the collection element position information and the collection element attribute corresponding to each of the target road elements acquired by each of the target vehicles with the original element position information and the original element attribute corresponding to each of the target road elements, respectively, to obtain pieces of second comparison result information corresponding to each of the target road elements;
determining the number of pieces of error comparison result information corresponding to the target road element according to the pieces of second comparison result information corresponding to the target road element;
obtaining an updated confidence value corresponding to the target road element by subtracting a product of a second preset confidence threshold and the number of the pieces of error comparison result information corresponding to the target road element from the original confidence value corresponding to the target road element;
determining a first updated confidence value corresponding to the target road section according to the updated confidence value corresponding to each of the target road elements; and
updating the original confidence value corresponding to the target road section in the high-precision map using the first updated confidence value corresponding to the target road section.

6. The method according to claim 1, wherein updating the original confidence value corresponding to the target road section in the high-precision map according to the pieces of first comparison result information corresponding to each of the target vehicles comprises:
subtracting a first preset confidence threshold corresponding to the target road element from an original confidence value corresponding to the target road element to obtain an updated confidence value corresponding to the target road element, when a proportion of the number of pieces of error comparison result information in the pieces of first comparison result information corresponding to the target road element to the number of the pieces of first comparison result information is greater than a preset proportion threshold;
determining a first updated confidence value corresponding to the target road section according to the updated confidence value corresponding to each of the target road elements; and
updating the original confidence value corresponding to the target road section in the high-precision map using the first updated confidence value corresponding to the target road section.

7. The method according to claim 1, wherein updating the original confidence value corresponding to the target road section in the high-precision map according to the pieces of first comparison result information corresponding to each of the target vehicles comprises:
determining the number of pieces of error comparison result information corresponding to the target road element according to the pieces of first comparison result information corresponding to the target road element;
obtaining an updated confidence value corresponding to the target road element by subtracting a product of a second preset confidence threshold and the number of pieces of error comparison result information corresponding to the target road element from an original confidence value corresponding to the target road element;
determining a first updated confidence value corresponding to the target road section according to the updated confidence value corresponding to each of the target road elements; and
updating the original confidence value corresponding to the target road section in the high-precision map using the first updated confidence value corresponding to the target road section.

8. The method according to claim 4, further comprising:
transmitting the first updated confidence value corresponding to the target road section to the target vehicles or other vehicles to enable the target vehicles or the other vehicles to select an automatic driving mode according to the first updated confidence value corresponding to the target road section in passing through the target road section.

9. The method according to claim 1, further comprising:
subtracting a third preset confidence threshold from the original confidence value corresponding to the target road section to obtain a second updated confidence value corresponding to the target road section, in response to receiving no confidence updating data packet corresponding to the target road section within a preset time period; and
updating the original confidence value corresponding to the target road section in the high-precision map using the second updated confidence value corresponding to the target road section.

10.-14. (canceled)

15. A storage medium having stored therein instructions that, when executed, control a device in which the storage medium is disposed to execute a method for updating a confidence of a high-precision map, wherein the method comprises:
acquiring confidence updating data packets corresponding to target vehicles, wherein the confidence updating data packets corresponding to the target vehicles are confidence updating data packets uploaded to a cloud server when each of the target vehicles passes through a target road section within a target time period, the target road section comprises a plurality of target road elements, the confidence updating data packets comprise target road element images corresponding to each of the target road elements, shooting position information corresponding to each of the target road element images and a camera calibration file, or the confidence updating data packets comprise pieces of first comparison result information corresponding to each of the target road elements;
updating an original confidence value corresponding to the target road section in the high-precision map according to the target road element images corresponding to each of the target vehicles, the shooting position information corresponding to each of the target road element images and the camera calibration file; or
updating the original confidence value corresponding to the target road section in the high-precision map according to the pieces of first comparison result information corresponding to each of the target vehicles.

16. An apparatus for updating a confidence of a high-precision map, comprising:
a storage medium; and
one or more processors, coupled to the storage medium,
wherein the one or more processors are configured to execute program instructions stored in the storage medium, and the program instructions, when executed, cause a method for updating a confidence of a high-precision map to be performed, wherein the method comprises:
acquiring confidence updating data packets corresponding to target vehicles, wherein the confidence updating data packets corresponding to the target vehicles are confidence updating data packets uploaded to a cloud server when each of the target vehicles passes through a target road section within a target time period, the target road section comprises a plurality of target road elements, the confidence updating data packets comprise target road element images corresponding to each of the target road elements, shooting position information corresponding to each of the target road element images and a camera calibration file, or the confidence updating data packets comprise pieces of first comparison result information corresponding to each of the target road elements;
updating an original confidence value corresponding to the target road section in the high-precision map according to the target road element images corresponding to each of the target vehicles, the shooting position information corresponding to each of the target road element images and the camera calibration file; or
updating the original confidence value corresponding to the target road section in the high-precision map according to the pieces of first comparison result information corresponding to each of the target vehicles.

17. The apparatus according to claim 16, wherein updating the original confidence value corresponding to the target road section in the high-precision map according to the target road element images corresponding to each of the target vehicles, the shooting position information corresponding to each of the target road element images and the camera calibration file comprises:
determining collection element position information and a collection element attribute corresponding to each of the target road elements acquired by each of the target vehicles according to the target road element images corresponding to each of the target vehicles, the shooting position information corresponding to each of the target road element images and the camera calibration file, wherein the collection element position information corresponding to each of the target road elements is position information of the target road element relative to the high-precision map; and
updating the original confidence value corresponding to the target road section in the high-precision map according to the collection element position information and the collection element attribute corresponding to each of the target road elements acquired by each of the target vehicles.

18. The apparatus according to claim 17, wherein determining the collection element position information and the collection element attribute corresponding to each of the target road elements acquired by each of the target vehicles according to the target road element images corresponding to each of the target vehicles, the shooting position information corresponding to each of the target road element images and the camera calibration file comprises:
determining a first position and the collection element attribute corresponding to each of the target road elements acquired by the target vehicle according to a preset perceptual recognition algorithm and the target road element images corresponding to the target vehicle, wherein the first position corresponding to the target road element is a position of the target road element in a respective target road element image;
determining a second position corresponding to each of the target road elements acquired by the target vehicle according to the first position corresponding to each of the target road elements acquired by the target vehicle and the camera calibration file corresponding to the target vehicle, wherein the second position corresponding to the target road element is a position of the target road element relative to the target vehicle; and
determining the collection element position information corresponding to each of the target road elements acquired by each of the target vehicles according to the second position corresponding to each of the target road elements acquired by the target vehicle and the shooting position information corresponding to each of the target road element images.

19. The apparatus according to claim 17, wherein updating the original confidence value corresponding to the target road section in the high-precision map according to the collection element position information and the collection element attribute corresponding to each of the target road elements acquired by each of the target vehicles comprises:
acquiring original element position information, an original element attribute and an original confidence value corresponding to each of the target road elements from the high-precision map;
comparing the collection element position information and the collection element attribute corresponding to each of the target road elements acquired by each of the target vehicles with the original element position information and the original element attribute corresponding to each of the target road elements, respectively, to obtain pieces of second comparison result information corresponding to each of the target road elements;
subtracting a first preset confidence threshold corresponding to a target road element from the original confidence value corresponding to the target road element to obtain an updated confidence value corresponding to the target road element, when a proportion of the number of pieces of error comparison result information in the pieces of second comparison result information corresponding to the target road element to the number of the pieces of second comparison result information is greater than a preset proportion threshold;
determining a first updated confidence value corresponding to the target road section according to the updated confidence value corresponding to each of the target road elements; and
updating the original confidence value corresponding to the target road section in the high-precision map using the first updated confidence value corresponding to the target road section.

20. The apparatus according to claim 17, wherein updating the original confidence value corresponding to the target road section in the high-precision map according to the collection element position information and the collection element attribute corresponding to each of the target road elements acquired by each of the target vehicles comprises:
acquiring original element position information, an original element attribute and an original confidence value corresponding to each of the target road elements from the high-precision map;
comparing the collection element position information and the collection element attribute corresponding to each of the target road elements acquired by each of the target vehicles with the original element position information and the original element attribute corresponding to each of the target road elements, respectively, to obtain pieces of second comparison result information corresponding to each of the target road elements;
determining the number of pieces of error comparison result information corresponding to the target road element according to the pieces of second comparison result information corresponding to the target road element;
obtaining an updated confidence value corresponding to the target road element by subtracting a product of a second preset confidence threshold and the number of the pieces of error comparison result information corresponding to the target road element from the original confidence value corresponding to the target road element;
determining a first updated confidence value corresponding to the target road section according to the updated confidence value corresponding to each of the target road elements; and
updating the original confidence value corresponding to the target road section in the high-precision map using the first updated confidence value corresponding to the target road section.

21. The apparatus according to claim 16, wherein updating the original confidence value corresponding to the target road section in the high-precision map according to the pieces of first comparison result information corresponding to each of the target vehicles comprises:
subtracting a first preset confidence threshold corresponding to the target road element from an original confidence value corresponding to the target road element to obtain an updated confidence value corresponding to the target road element, when a proportion of the number of pieces of error comparison result information in the pieces of first comparison result information corresponding to the target road element to the number of the pieces of first comparison result information is greater than a preset proportion threshold;
determining a first updated confidence value corresponding to the target road section according to the updated confidence value corresponding to each of the target road elements; and
updating the original confidence value corresponding to the target road section in the high-precision map using the first updated confidence value corresponding to the target road section.

22. The apparatus according to claim 16, wherein updating the original confidence value corresponding to the target road section in the high-precision map according to the pieces of first comparison result information corresponding to each of the target vehicles comprises:
determining the number of pieces of error comparison result information corresponding to the target road element according to the pieces of first comparison result information corresponding to the target road element;
obtaining an updated confidence value corresponding to the target road element by subtracting a product of a second preset confidence threshold and the number of pieces of error comparison result information corresponding to the target road element from an original confidence value corresponding to the target road element;
determining a first updated confidence value corresponding to the target road section according to the updated confidence value corresponding to each of the target road elements; and
updating the original confidence value corresponding to the target road section in the high-precision map using the first updated confidence value corresponding to the target road section.

23. The method according to claim 5, further comprising:
transmitting the first updated confidence value corresponding to the target road section to the target vehicles or other vehicles to enable the target vehicles or the other vehicles to select an automatic driving mode according to the first updated confidence value corresponding to the target road section in passing through the target road section.

24. The method according to claim 6, further comprising:
transmitting the first updated confidence value corresponding to the target road section to the target vehicles or other vehicles to enable the target vehicles or the other vehicles to select an automatic driving mode according to the first updated confidence value corresponding to the target road section in passing through the target road section.

25. The method according to claim 7, further comprising:
transmitting the first updated confidence value corresponding to the target road section to the target vehicles or other vehicles to enable the target vehicles or the other vehicles to select an automatic driving mode according to the first updated confidence value corresponding to the target road section in passing through the target road section.
